(19) United States
(12) Patent Application Publication
(10) Pub. No.: US 2010/0031950 A1
(43) Pub. Date: Feb. 11, 2010

(54) COOLER INCORPORATING GRILLING APPARATUS

(75) Inventor: Ray N. Paslawski, Wildwood, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: POSITIVE OUTCOMES, INC., Wildwood, MO (US)

(21) Appl. No.: 12/483,841

(22) Filed: Jun. 12, 2009

Related U.S. Application Data
(63) Continuation-in-part of application No. 29/322,536, filed on Aug. 6, 2008, now Pat. No. D604108.

(51) Int. Cl. A47J 37/06; F25D 3/08; A47J 37/07

(52) U.S. Cl. 126/25 R; 62/457.1; 126/9 R

(57) ABSTRACT

An apparatus including a cooler and a grill. The cooler may be used to store a plurality of foodstuffs. The grill may be used for cooking. The grill is attached to the cooler by a sliding attachment that allows the grill and the cooler to be in a first, collapsed position whereby the grill and the cooler are maintained in a close proximity to one another for transportation and a second, expanded position whereby the grill and the cooler are maintained in a more distant proximity to one another than the collapsed position for cooking upon the grill. A grill compartment may also be included.

The present invention claims priority to U.S. Design Pat. Application No. 29/322,536 filed Aug. 6, 2008. The contents of said application are incorporated herein by reference.

### FIELD OF THE INVENTION

This invention relates generally to the fields of cooler apparatus and grilling apparatus.

### BACKGROUND OF THE INVENTION

Tailgating is a popular social activity particularly before, after and sometimes during sporting events and musical concerts. Tailgate parties typically occur in parking lots near the event and tailgaters normally consume beverages and grill meat. It is estimated the 50 million people per year participate in tailgate parties and spend $50 billion in tailgating supplies and equipment. Moreover, several television shows have glorified tailgate parties before sporting events such as ESPN television's pre-game college football show College GameDay. Television broadcaster John Madden has likewise popularized tailgating by taking cameras into sports parking lots and has written a book about tailgating entitled John Madden's Ultimate Tailgating. Additionally, picnickers and park goers similarly typically consume beverages and grill food while enjoying the outdoors, celebrating an event or participating in sports.

A problem that can occur with tailgating or picnicking is the difficulty with easily transporting supplies and minimizing the effort required to participate in what is supposed to be a fun and relaxing activity. Transporting coolers, beverages, meat, charcoal and grills is a hassle that most people would prefer to minimize in order to make the experience more pleasant. Currently, there is no solution that addresses all of these concerns in a compact and relatively inexpensive piece of equipment.

With the large amount of interest in tailgating and other outdoor events, there is a need in the art to simplify what is intended to be an enjoyable task such as minimizing the effort required to transport and prepare food, drink and equipment in order to enjoy a tailgate party or outdoor picnic.

Other attempts have been made to meet this end, but fall short. U.S. Pat. No. 2,608,191 is a cooler that may be converted to a cookstove to grill food. However, this device does not allow the simultaneous use of the device as both as cooler and cookstove such that beverages may be cooled while food is cooked. U.S. Pat. No. 6,575,155 describes a gurney-type device upon which is mounted a common cookstove and grill. This device is bulky, heavy and not suited for rough terrain. U.S. Pat. No. 5,154,158 incorporates an electric cookstove mounted within the lid of a common cooler. This device suffers the deficiency of preventing access to the interior of the cooler while the cookstove is in use.

### SUMMARY OF THE INVENTION

The present invention comprises an apparatus comprising a cooler and a grill. The cooler may be used to store a plurality of foodstuffs. The grill may be used for cooking. The grill is attached to the cooler by a sliding attachment that allows the grill and the cooler to be in a first, collapsed position whereby the grill and the cooler are maintained in a close proximity to one another for transportation and a second, expanded position whereby the grill and the cooler are maintained in a more distant proximity to one another than the collapsed position for cooking upon the grill. A grill compartment may also be included.

### DESCRIPTION OF THE DRAWINGS

FIG. 1 is a front perspective view of a cooler incorporating a grill apparatus according to an embodiment of the present invention;

FIG. 2 is a front view of a cooler incorporating a grill apparatus according to an embodiment of the present invention;

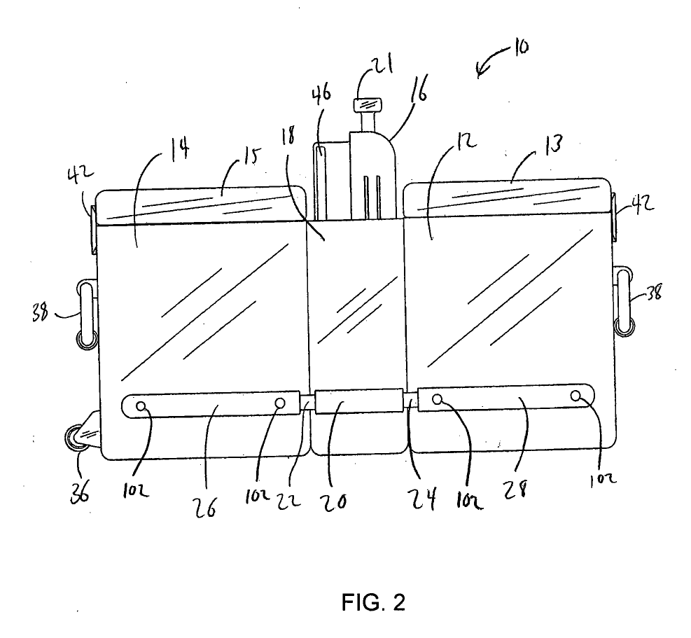

FIG. 3 is a rear view of a cooler incorporating a grill apparatus according to an embodiment of the present invention;

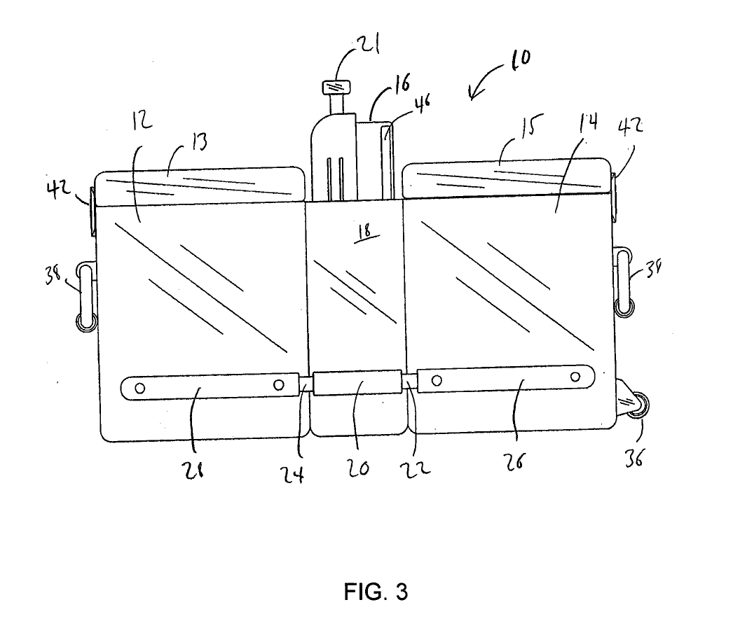

FIG. 4 is a top view of a cooler incorporating a grill apparatus according to an embodiment of the present invention;

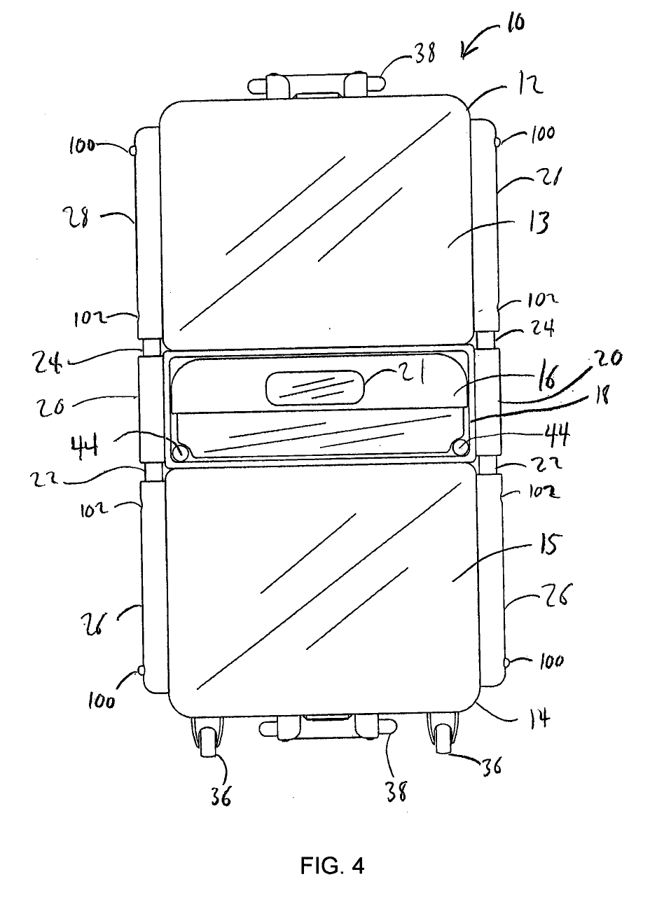

FIG. 5 is a bottom view of a cooler incorporating a grill apparatus according to an embodiment of the present invention;

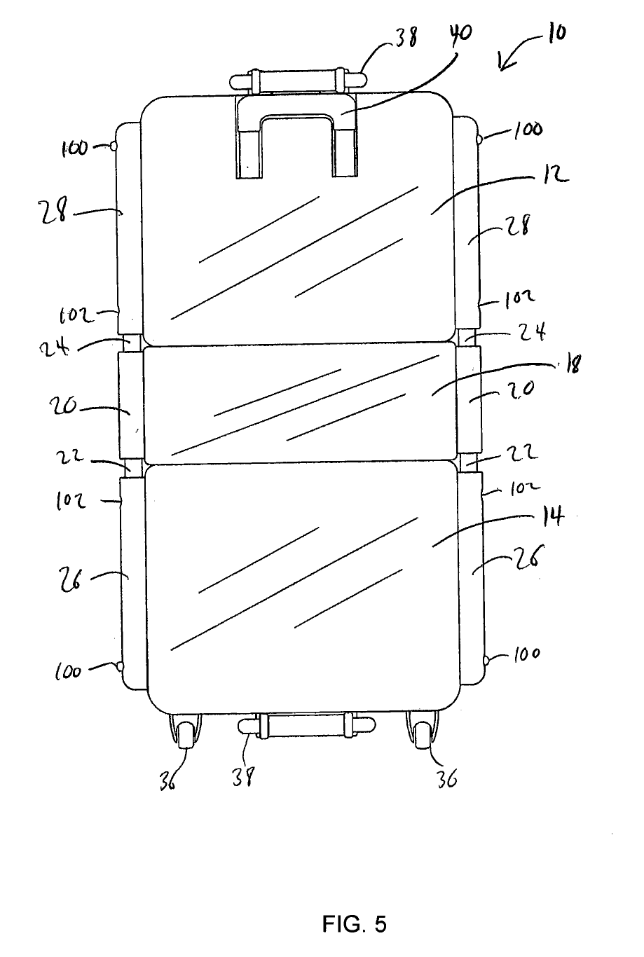

FIG. 6 is a left view of a cooler incorporating a grill apparatus according to an embodiment of the present invention;

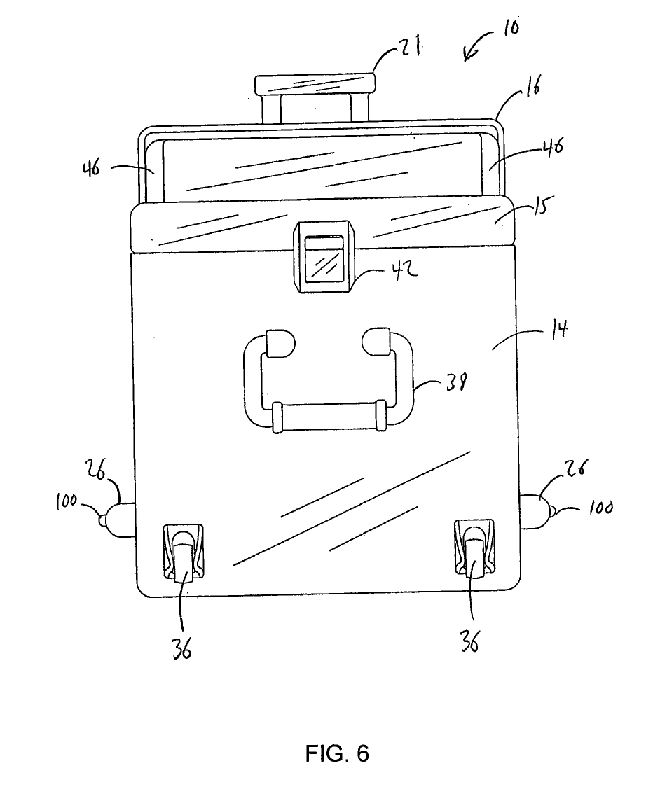

FIG. 7 is a right view of a cooler incorporating a grill apparatus according to an embodiment of the present invention;

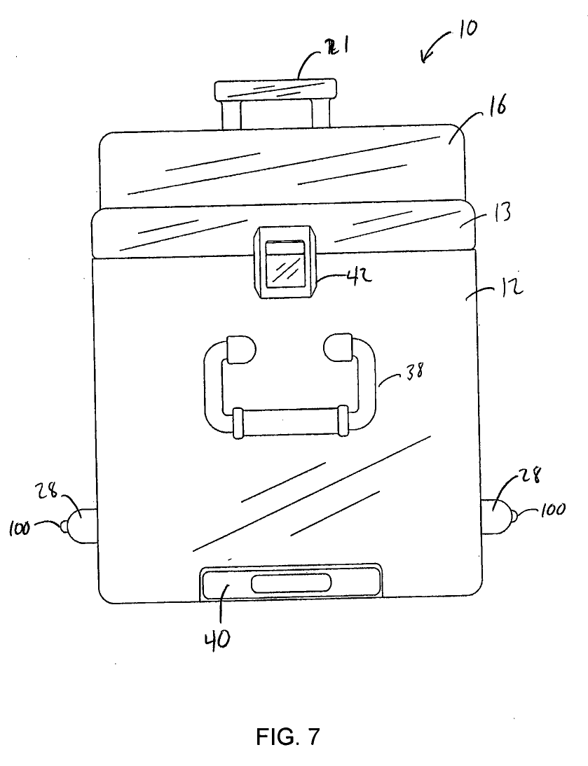

FIG. 8 is a front perspective view of a cooler incorporating a grill apparatus having the coolers extended and the grill mounted according to an embodiment of the present invention;

FIG. 9 is a front view of a cooler incorporating a grill apparatus having the coolers extended and the grill mounted according to an embodiment of the present invention;

FIG. 10 is a rear view of a cooler incorporating a grill apparatus having the coolers extended and the grill mounted according to an embodiment of the present invention;

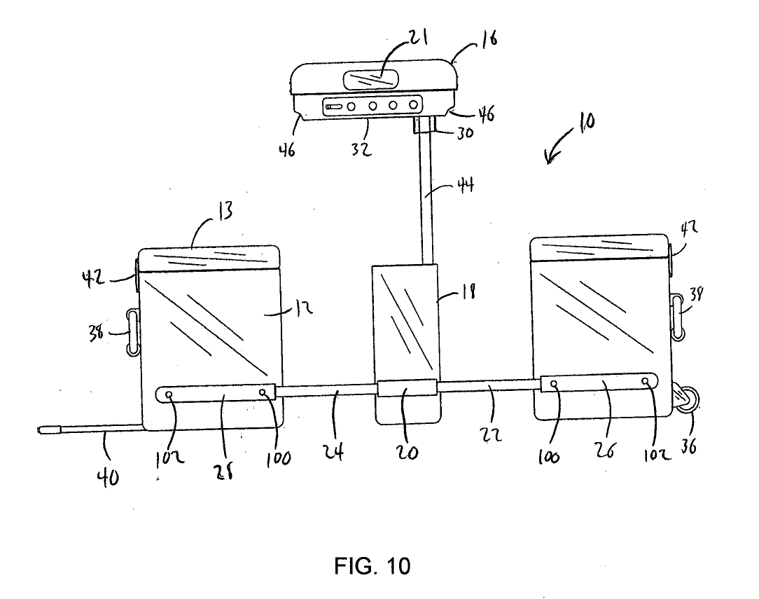

FIG. 11 is a front perspective view of a cooler incorporating a grill apparatus having the coolers extended and opened and the grill mounted and opened according to an embodiment of the present invention;

FIG. 12 is a front view of a cooler incorporating a grill apparatus having the coolers extended and opened and the grill mounted and opened according to an embodiment of the present invention;

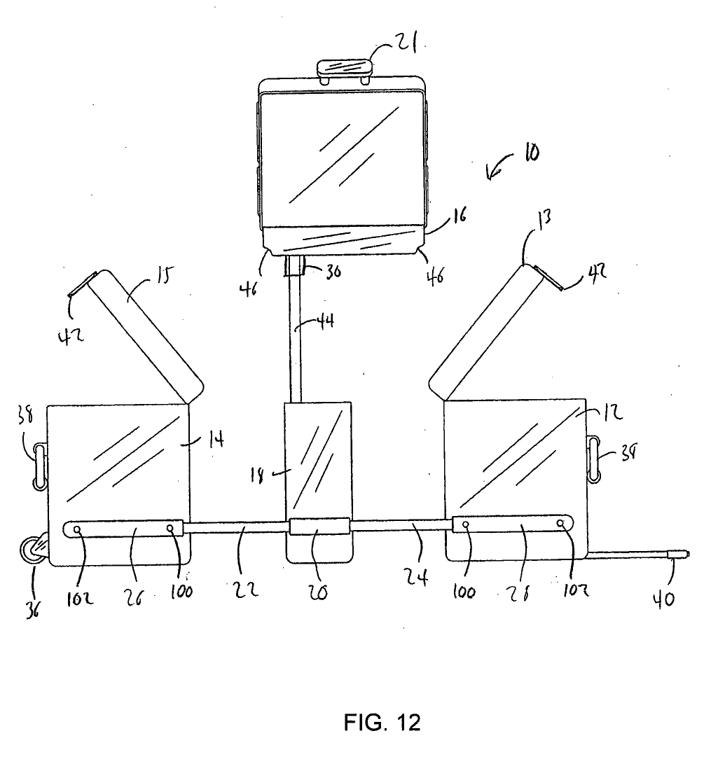

FIG. 13 is a view of the interior of the grill compartment according to an embodiment of the present invention;

FIG. 14 is a top view of a cooler incorporating a grill apparatus according to a second embodiment of the present invention;

FIG. 15 is a perspective view of a cooler incorporating a grill apparatus according to a second embodiment of the present invention;

FIG. 16 is a perspective view of a cooler incorporating a grill apparatus according to a third embodiment of the present invention;

FIG. 17 is another perspective view of a cooler incorporating a grill apparatus according to a third embodiment of the present invention;

FIG. 18 is a front view of a cooler incorporating a grill apparatus according to a third embodiment of the present invention;

FIG. 19 is a rear view of a cooler incorporating a grill apparatus according to a third embodiment of the present invention;

FIG. 20 is a top view of a cooler incorporating a grill apparatus according to a third embodiment of the present invention;

FIG. 21 is a bottom view of a cooler incorporating a grill apparatus according to a third embodiment of the present invention;

FIG. 22 is a left side view of a cooler incorporating a grill apparatus according to a third embodiment of the present invention;

FIG. 23 is a right side view of a cooler incorporating a grill apparatus according to a third embodiment of the present invention;

FIG. 24 is a front view of a cooler incorporating a grill apparatus according to a third embodiment of the present invention;

FIG. 25 is a view of a cooler incorporating a grill apparatus having the cooler extended and opened and the grill mounted according to a third embodiment of the present invention;

FIG. 26 is a view of a cooler incorporating a grill apparatus having the cooler extended and opened and the grill mounted and opened according to a third embodiment of the present invention;

FIG. 27 is a perspective view of a cooler incorporating a grill apparatus having the cooler extended and opened and the grill mounted according to a third embodiment of the present invention;

FIG. 28 is a perspective view of a cooler incorporating a grill apparatus having the cooler extended and opened and the grill mounted and opened according to a third embodiment of the present invention; and

FIG. 29-30 are perspective views of a cooler incorporating a grill incorporating a propane tank according to another embodiment of the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention comprises a combined cooler and grilling device which is easily transportable, relatively compact and allows simultaneous use and access to the cooler and grill portion of the device.

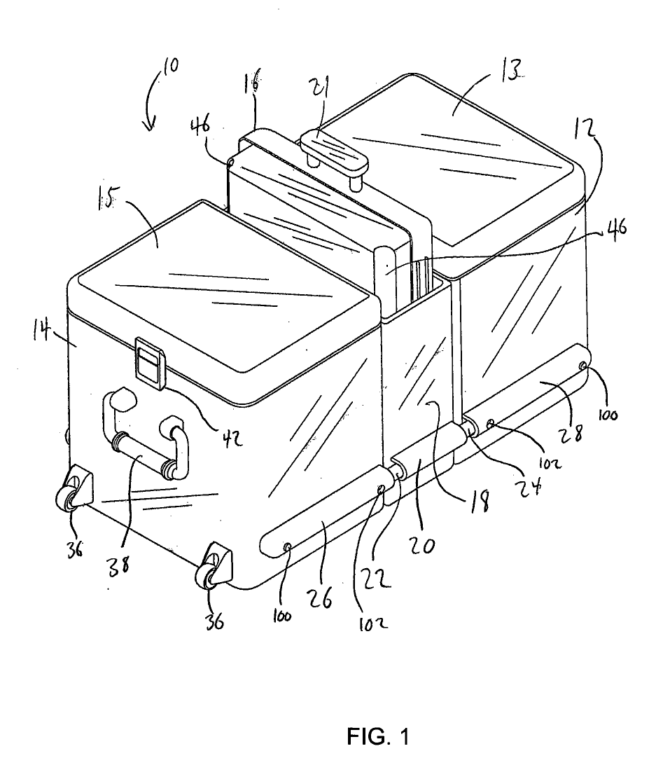

To this end, the best and preferred embodiment known to the inventor is disclosed below and in the drawings. Referring to FIG. 1, a device 10 comprises a combination of two coolers 12 and 14 (each having cooler closures 13 and 15, respectively) and a grill 16. The grill 16 is positioned between the coolers 12 and 14 within a grill compartment 18. Attached to an exterior of the grill compartment 18 is a cooler mounting member 20. Disposed within the grill compartment mounting member 20 and extending from opposite ends thereof are telescoping rods 22 and 24. The telescoping rods 22 and 24 are each mounted at an opposite end from the grill compartment mounting member 20 to cooler mounting members 26 and 28. The cooler mounting members 26 and 28 are associated with each cooler 12 and 14.

The telescoping rods 22 and 24, when in a collapsed state as in FIG. 1, provide for a compact arrangement of the coolers 12 and 14 and the grill 16/grill compartment 18. As can be seen in FIG. 1, the grill 16 is stored within the grill compartment 18 for easy storage of the grill 16 and transportation of the device 10 as a single unit.

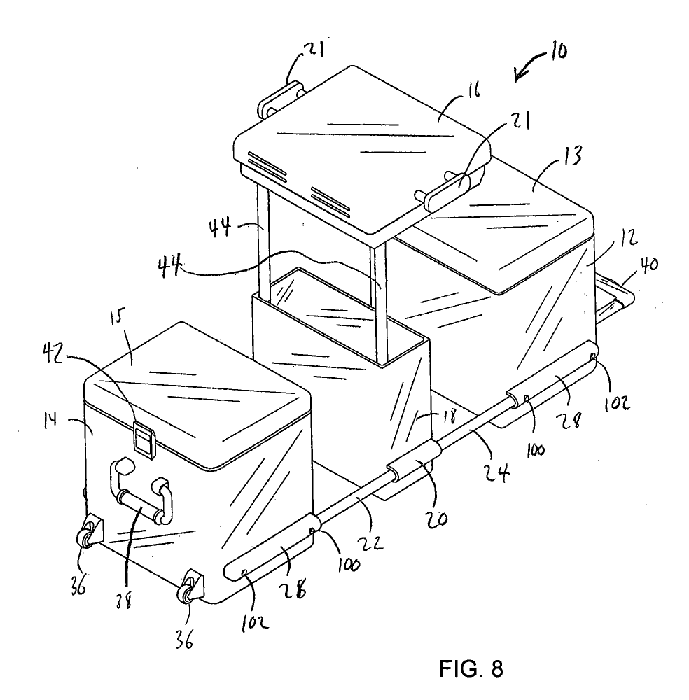

The telescoping rods 22 and 24, when in an extended state as in FIG. 8, provide for an expanded arrangement of the coolers 12 and 14. Cooperating ball 100 and detent 102 mechanisms may optionally lock the telescoping rods 22 and 24 in the extended state while allowing them to later selectively be retracted to a collapsed state and locked in such state.

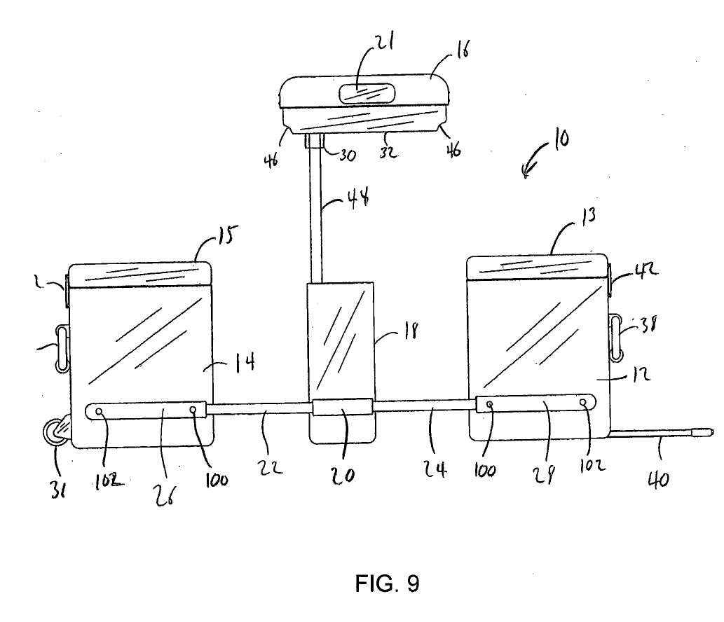

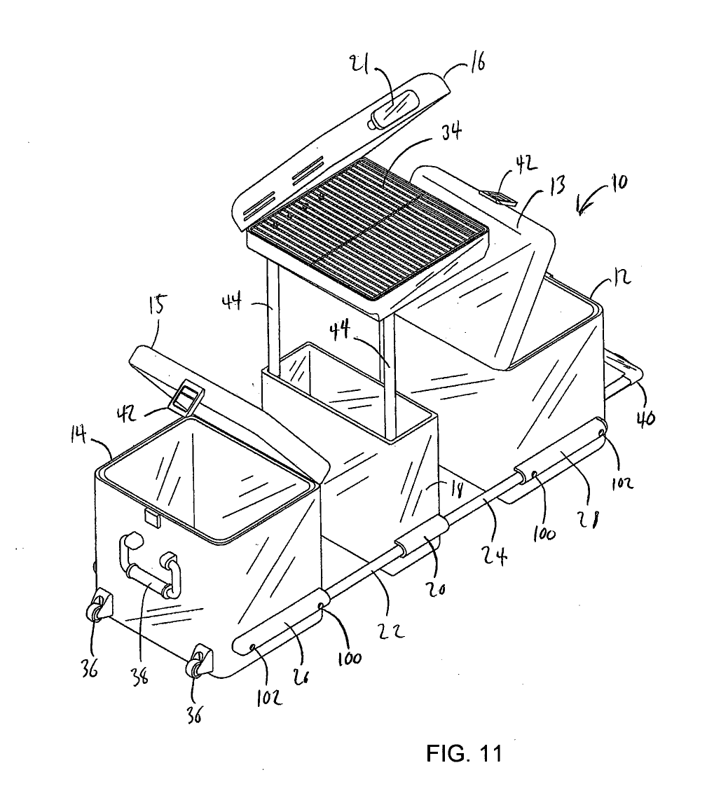

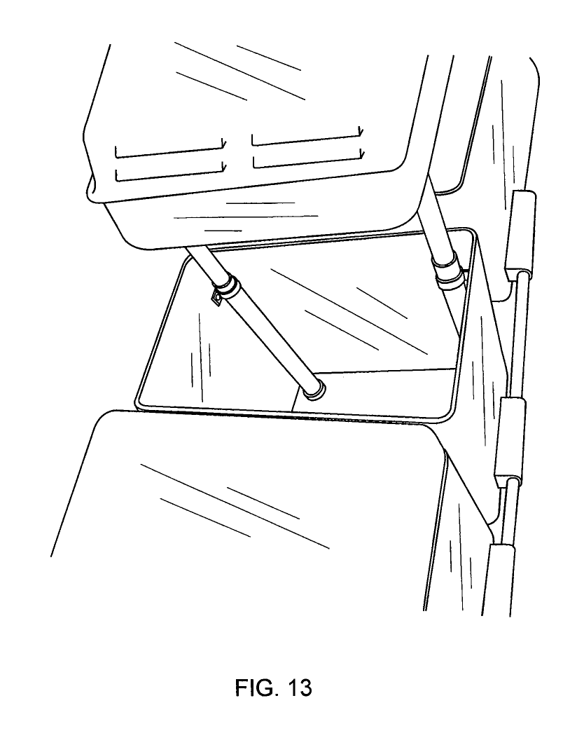

Grill support rods 44 further provide for support of the grill 16 in a grilling position. Specifically shown in FIG. 9, the grill 16 may be placed on the extended telescoping grill support rods 44 by placing the rods 44 within grill support housings 30 associated with a base 32 of the grill 16. Opposite the grill support housings 30 the rods 44 are further supported within the grill compartment 18 by grill compartment housings 31 (FIG. 13). Referring to FIG. 11, a grilling surface 34 is associated with the grill 16 for placing a combustible fuel, for example charcoal or propane, under the grilling surface 34 and food to be grilled upon the grilling surface 34. Grill handles 21 facilitate lifting of the grill 16 and opening of a grill lid 23. The grilling support rods may be held in place by a suitable locking mechanism, such as a ball and detent arrangement.

In this manner, the grill 16 may be supported with sufficient distance from the coolers 12 and 14 such that heat from the grill 16 while grilling will not unduly warm the coolers 12 and 14.

As can further be seen in FIG. 1, the grill 16 includes scalloped portions 46 which cooperate to provide a storage location for the grill support rods 44 when both the grill support rods 44 and the grill 16 are stored in the grill compartment 18.

Other features of the grill include wheels 36 for portability, handles 38 for lifting, and a retractable handle 40 for pulling the device 10 in conjunction with the wheels 36. Finally, closure locks 42 maintain the cooler closures 13 and 15 in a locked position.

To use the device 10 of the present invention, a user may load the coolers 12 and 14 with ice, beverages and food items and lock the closures 13 and 15 with the closure locks 42, as shown in FIG. 1. The user may then transport the device 10 to the location of an event. Upon reaching the event, the user will extend the telescoping rods 20 and 24 of the cooler mounting members 26 and 28 to extend the coolers 12 and 14 away from the grill compartment 18, as shown in FIG. 9. The user can further remove the grill 16 from the grill compartment 18 and place the grill 16 on the extended grill support rods 44 mounted within the grill support housings 30 and the grill compartment housings 31. The user may then utilize the grill 16 in a conventional way to cook food and open the cooler 12 and 14 to access food and beverages. After grilling is complete, the user may return the grill 16 to the grill compartment 18 and retract the coolers 12 and 14 and the grill support rods 44 to once again transport the device 10.

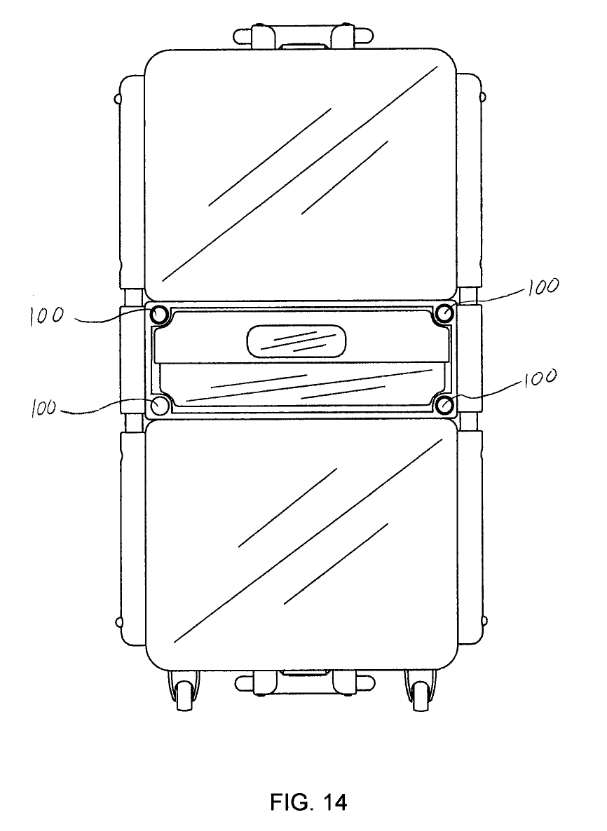

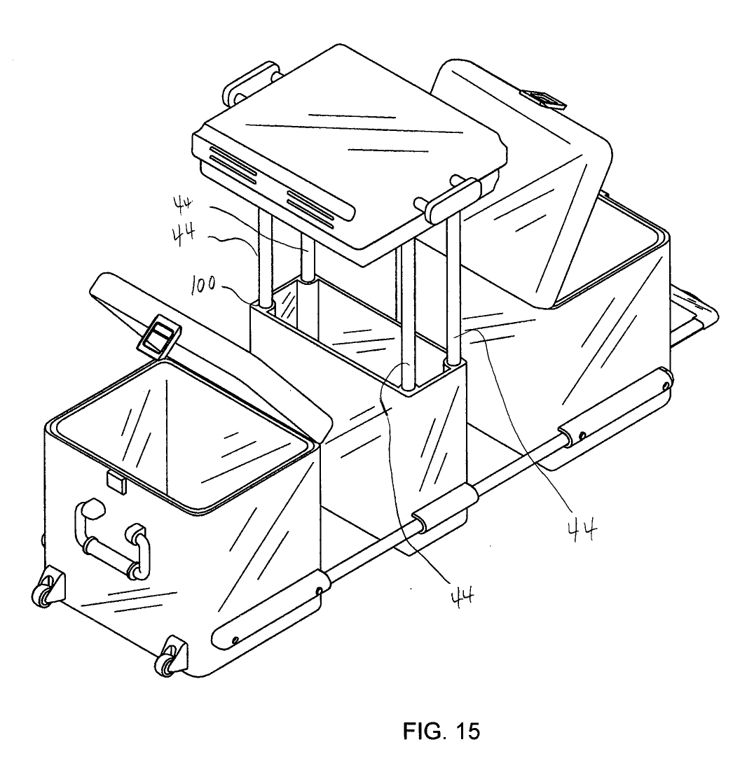

Referring to FIGS. 14-15, in an alternative embodiment of the present invention, the grill 16 is supported by four grill support rods 44 inserted within bores 100 formed within the grill compartment 18.

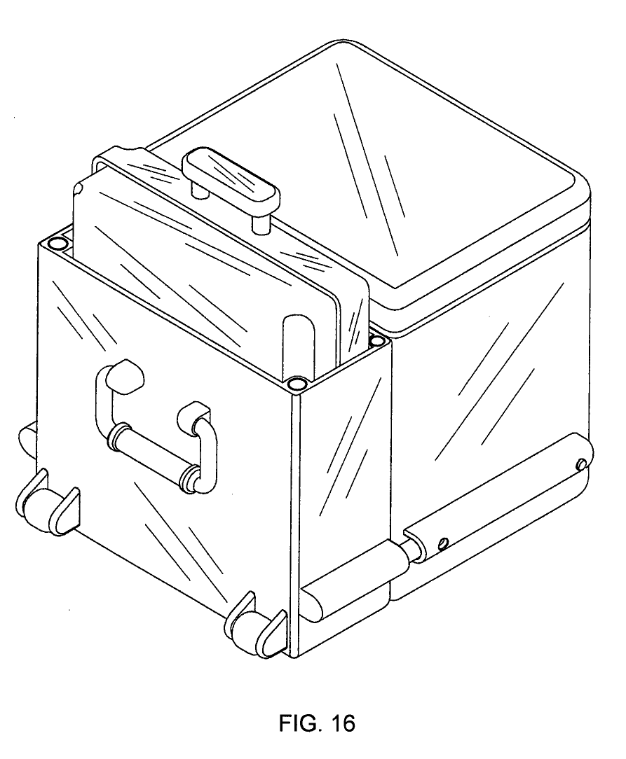

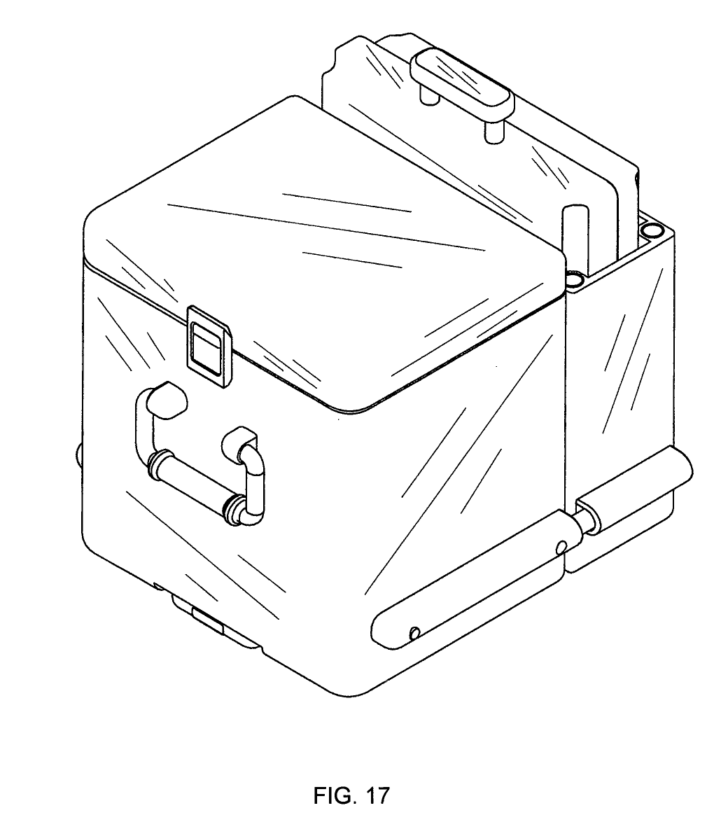

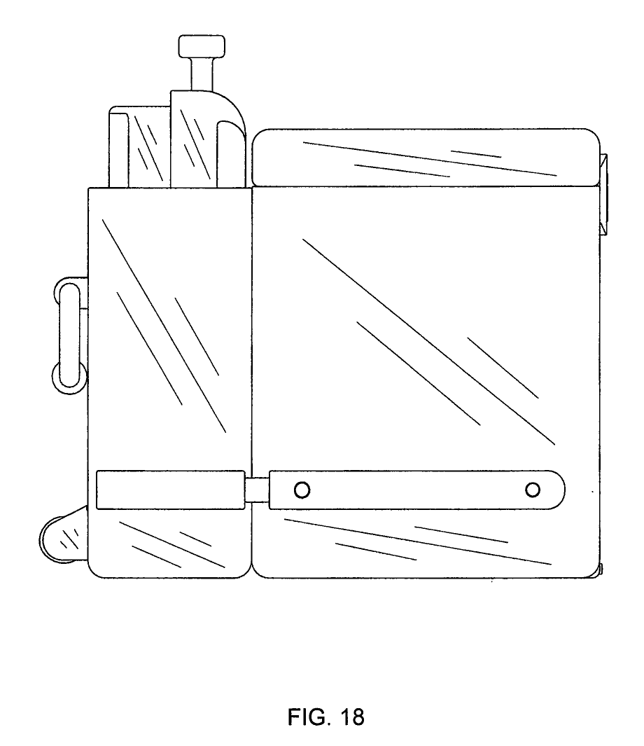

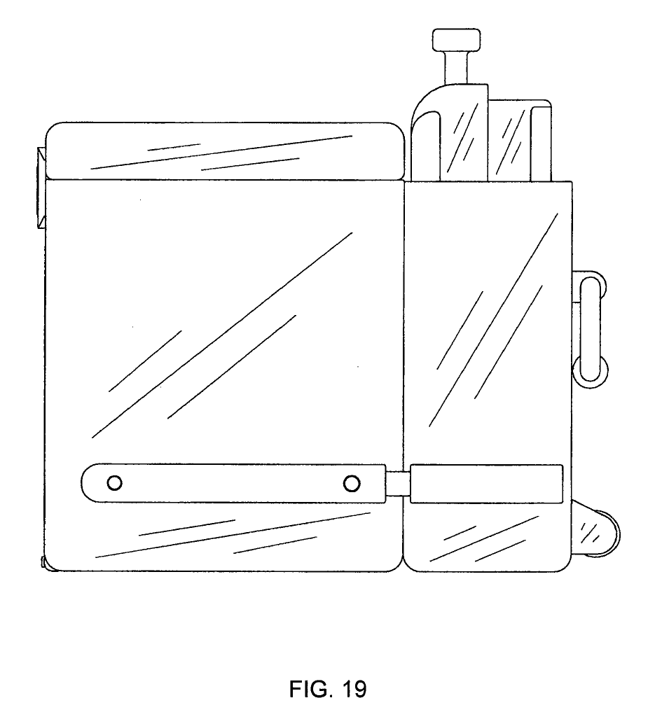

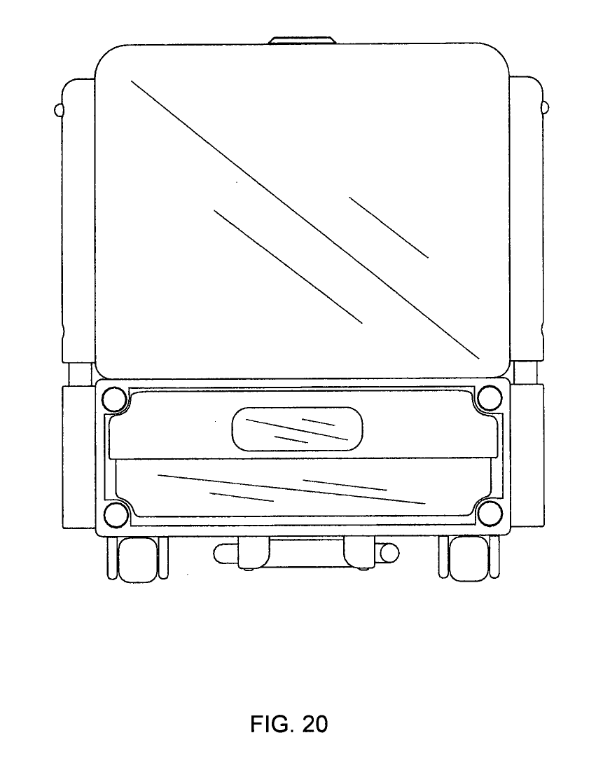

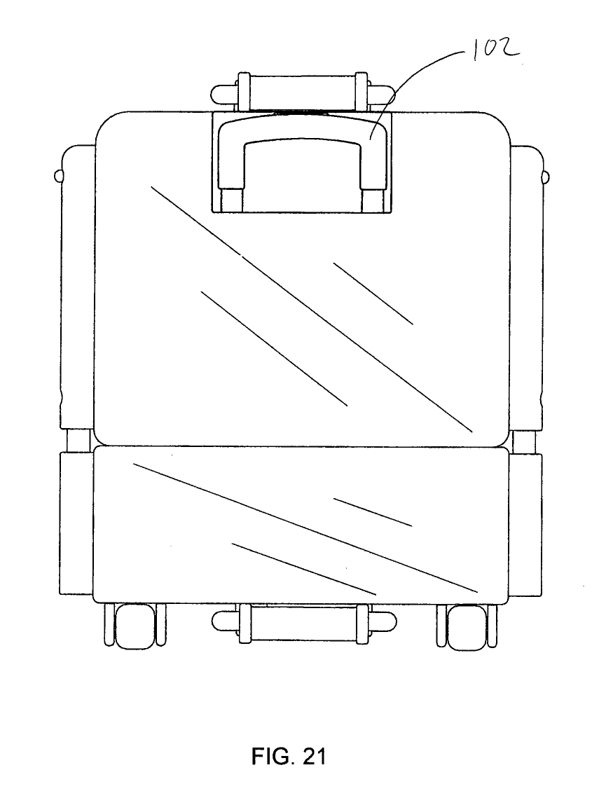

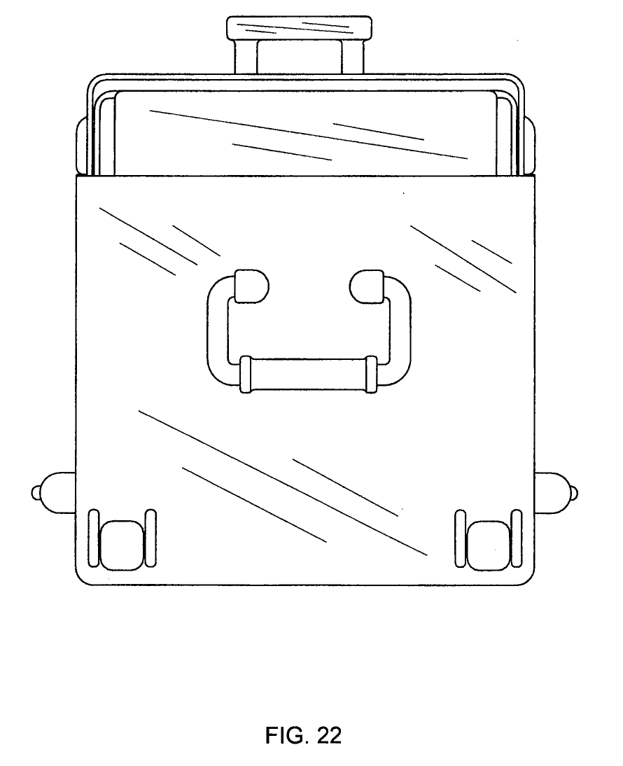

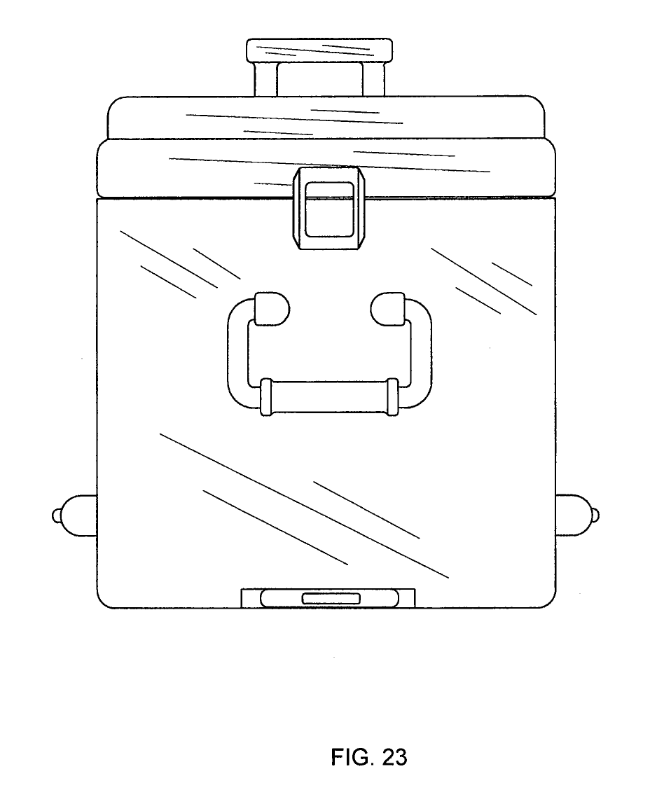

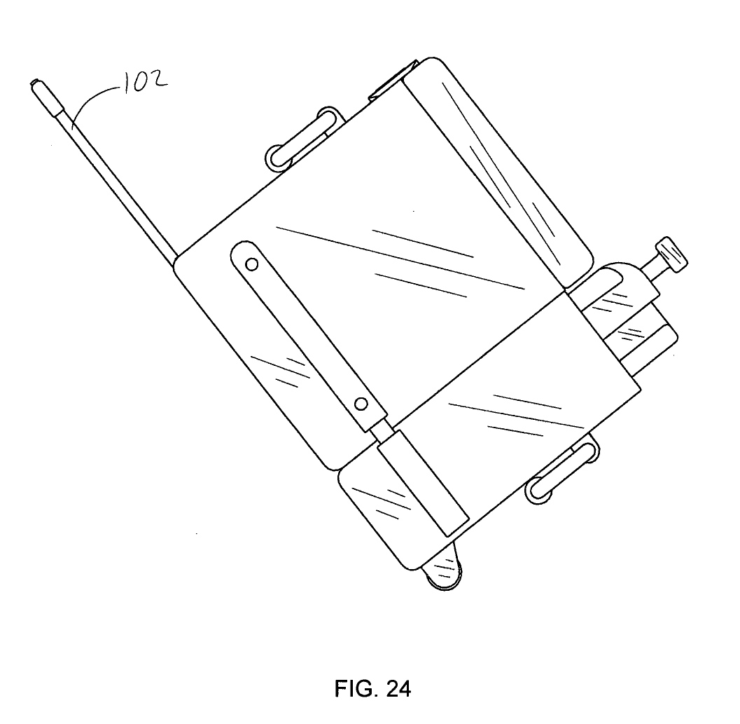

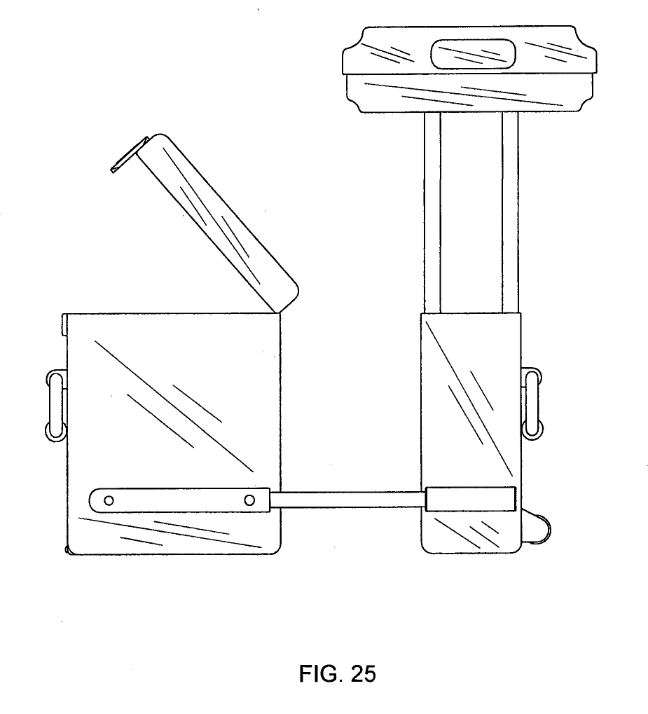

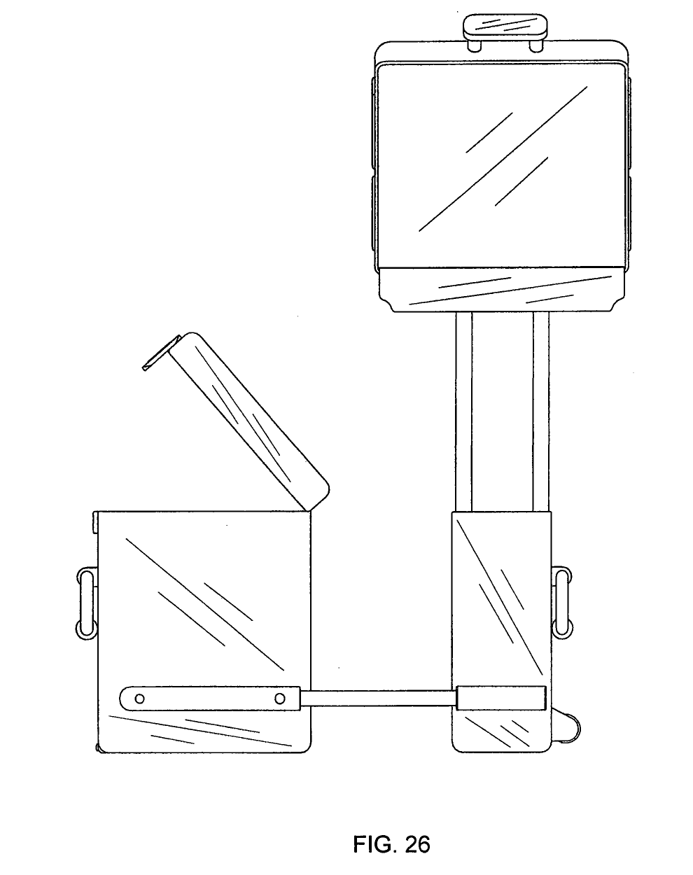

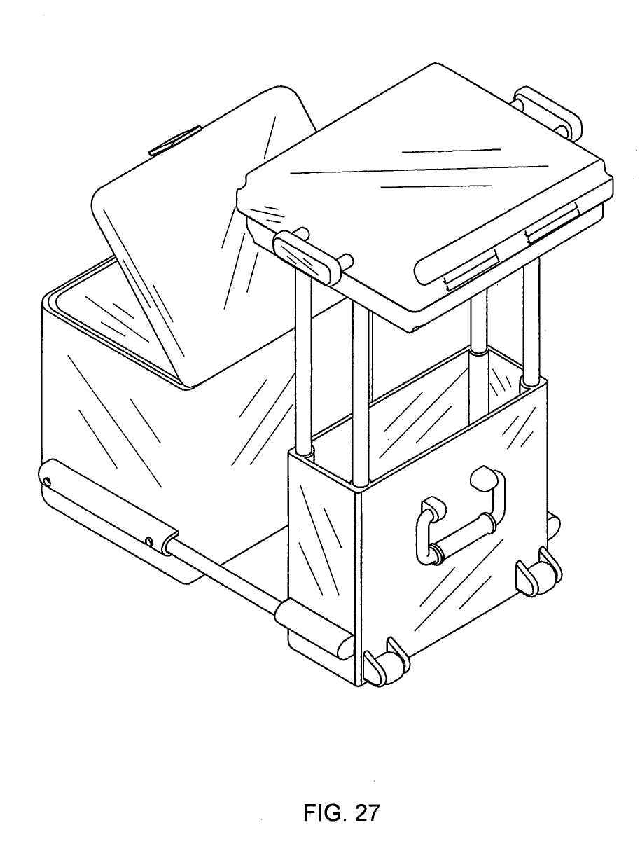

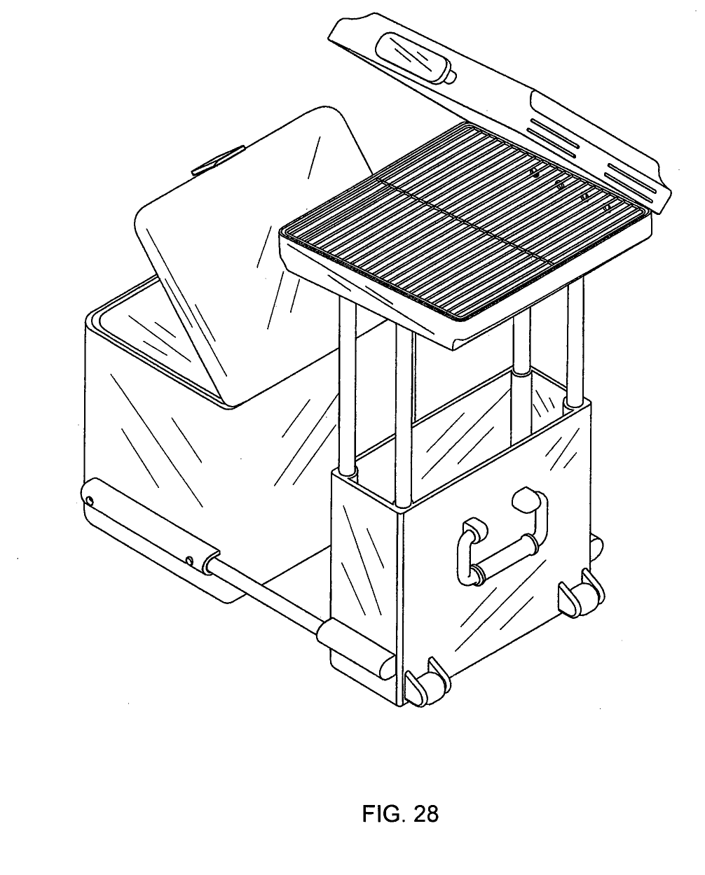

In the same manner, in an alternative embodiment the present invention may be implemented with only single cooler attached to the grill compartment for providing a more compact grill-cooler arrangement, as shown in FIGS. 16-28. Such an arrangement is accomplished by merely removing one of the coolers 12 or 14 and attaching a handle 21 and wheels 36 directly to the grill compartment 18. In order to accommodate the shorter length, the grill of this embodiment incorporates and extendable and retractable handle 102 (FIGS. 21 and 24).

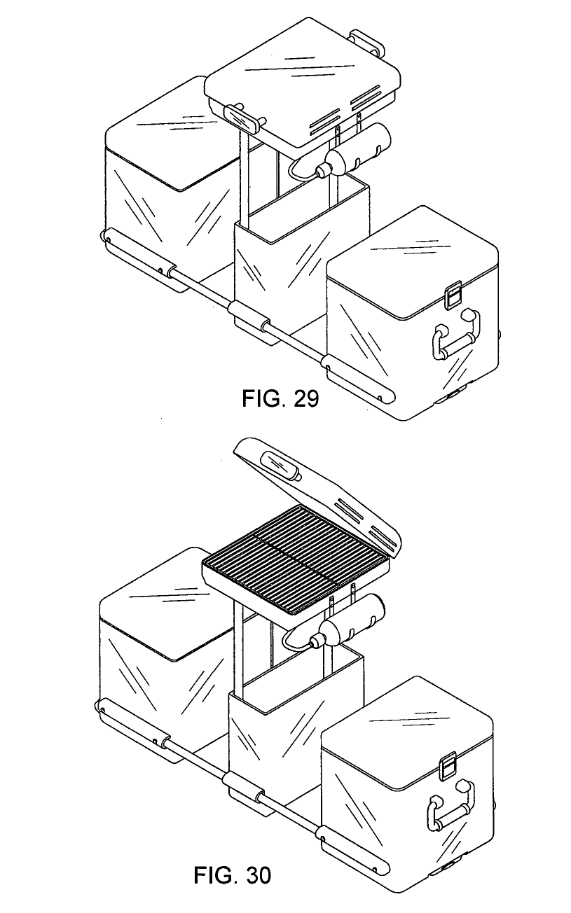

Referring to FIGS. 29 and 30, an embodiment of the present invention further provides a bracket 106 for retaining a propane tank 104 attached to a propane burner (not shown) as is known in the art.

The above examples show that the invention, as defined by the claims, has far ranging application and should not be limited merely to the embodiments shown and described in detail. Instead the invention should be limited only to the explicit words of the claims, and the claims should not be arbitrarily limited to embodiments shown in the specification. The scope of protection is only limited by the scope of the accompanying claims, and the Examiner should examine the claims on that basis.

I claim:

1. An apparatus comprising:
a cooler for storing a plurality of foodstuffs; and
a grill for cooking, the grill attached to the cooler by a sliding attachment that allows the grill and the cooler to be in a first, collapsed position whereby the grill and the cooler are maintained in a close proximity to one another for transportation and a second, expanded position whereby the grill and the cooler are maintained in a more distant proximity to one another than the collapsed position for cooking upon the grill.

2. The apparatus of claim 1 wherein the grill comprises a grill compartment adapted for storage of the grill when in the collapsed position and upon which the grill is adapted to be mounted for use when in the expanded position.

3. The apparatus of claim 2 wherein the grill is adapted to be mounted to the grill compartment with at least two rods mounted within bores of the grill compartment.

4. The apparatus of claim 1 wherein the cooler comprises a plurality of coolers mounted to the grill, the grill attached to at least one of the plurality of coolers by a sliding attachment that allows the grill and the one of the plurality of coolers to be in a first, collapsed position whereby the grill and the one of the plurality of coolers are maintained in a close proximity to one another for transportation and a second, expanded position whereby the grill and the one of the plurality of coolers are maintained in a more distant proximity to one another than the collapsed position for cooking.

5. The apparatus of claim 1 wherein the cooler comprises a plurality of coolers mounted to the grill, the grill attached to each of the plurality of coolers by sliding attachments that allows the grill and the coolers to be in a first, collapsed position whereby the grill and the coolers are maintained in a close proximity to one another for transportation and a second, expanded position whereby the grill and the coolers are maintained in a more distant proximity to one another than the collapsed position for cooking.

6. The apparatus of claim 1 wherein the apparatus has opposing ends and comprises a plurality of wheels attached to a first of the opposing ends and handle proximate a second of the opposing ends whereby a user may grasp the handle to roll the apparatus upon the wheels to transport the cooler and the grill when the cooler and the grill are in the collapsed position.

7. The apparatus of claim 6 wherein the handle is attached directly to the second of the opposing ends.

8. The apparatus of claim 6 wherein the handle is attached to the apparatus and may be selectively placed in a retracted position whereby it does not extend substantially beyond the second of the opposing ends and an expanded position whereby the handle extends substantially beyond the second of the opposing ends.

9. A combination cooler and grill apparatus comprising:
a cooler for storing a plurality of foodstuffs;
a grill compartment adapted to store a grill for cooking, the grill compartment attached to the cooler by a sliding attachment that allows the grill compartment and the cooler to be in a first, collapsed position whereby the grill compartment and the cooler are maintained in a close proximity to one another for transportation and a second, expanded position whereby the grill compartment and the cooler are maintained in a more distant proximity to one another than the collapsed position; and
a grill adapted to be selectively stored within the grill compartment or mounted to the apparatus for use.

10. The apparatus of claim 9 wherein the grill is adapted to be mounted to the grill compartment with at least two rods mounted within bores of the grill compartment.

11. The apparatus of claim 9 wherein the cooler comprises a plurality of coolers mounted to the grill compartment, the grill attached to at least one of the plurality of coolers by a sliding attachment that allows the grill compartment and the one of the plurality of coolers to be in a first, collapsed position whereby the grill compartment and the one of the plurality of coolers are maintained in a close proximity to one another for transportation and a second, expanded position whereby the grill compartment and the one of the plurality of coolers are maintained in a more distant proximity to one another than the collapsed position for cooking.

12. The apparatus of claim 9 wherein the cooler comprises a plurality of coolers mounted to the grill compartment, the grill compartment attached to each of the plurality of coolers by sliding attachments that allows the grill compartment and the coolers to be in a first, collapsed position whereby the grill compartment and the coolers are maintained in a close proximity to one another for transportation and a second, expanded position whereby the grill compartment and the coolers are maintained in a more distant proximity to one another than the collapsed position for cooking.

13. The apparatus of claim 9 wherein the apparatus has opposing ends and comprises a plurality of wheels attached to a first of the opposing ends and handle proximate a second of the opposing ends whereby a user may grasp the handle to roll the apparatus upon the wheels to transport the cooler and the grill compartment when the cooler and the grill are in the collapsed position.

14. The apparatus of claim 13 wherein the handle is attached directly to the second of the opposing ends.

15. The apparatus of claim 13 wherein the handle is attached to the apparatus and may be selectively placed in a retracted position whereby it does not extend substantially beyond the second of the opposing ends and an expanded position whereby the handle extends substantially beyond the second of the opposing ends.
